(19) United States
(12) Patent Application Publication
(10) Pub. No.: US 2026/0328799 A1
(43) Pub. Date: Oct. 22, 2026

(54) WIND SENSOR AND METHOD OF MAKING WIND DIRECTION AND WIND VELOCITY ESTIMATIONS

(71) Applicant: The Regents of the University of Michigan, Ann Arbor, MI (US)

(72) Inventors: Behdad Davoudi, Ann Arbor, MI (US); Ella Atkins, Ann Arbor, MI (US)

(21) Appl. No.: 19/104,691

(22) PCT Filed: Aug. 18, 2023
(86) PCT No.: PCT/US2023/030575

§ 371 Date: Feb. 18, 2025

Related U.S. Application Data
(60) Provisional application No. 63/398,990, filed on Aug. 18, 2022.

(51) Int. Cl. G01P 5/02; G01P 1/02; G01P 13/00

(52) U.S. Cl. CPC G01P 5/02; G01P 1/026; G01P 13/0013

(57) ABSTRACT

A wind sensor and a method of making wind flow direction and wind flow velocity estimations and predictions are set forth. The wind sensor has a spherical shell body, a multitude of pressure taps, and a multitude of pressure transducers. Size, weight, power, and cost (SWaP-C) optimizations can be effected in the design and construction of the wind sensor. An inverse mathematical model, as well as machine learning, are utilized in the wind flow direction and velocity estimations. Compared to past devices, the wind sensor

### TECHNICAL FIELD

This disclosure relates generally to wind sensors and, more particularly, relates to making wind direction and wind velocity estimations.

### BACKGROUND

Wind sensors measure wind direction and wind velocity, and are employed in a multitude of applications. Wind sensors and their measurements are useful in controlling navigation of unmanned aerial vehicles (UAVs), for instance, amid autonomous, semi-autonomous, and other operational modes, and especially when sudden and strong wind gusts are encountered during flight. Other specific applications include fume tracking for chemical and biological defense purposes, and anemotaxis as a key component of chemotaxis. Still, more generally, wind sensors may find ready employment in self-driving cars, wind farms, marine applications, and stationary weather stations, among many other possibilities. Past wind sensors have proved too large and/or too heavy for certain installations sensitive to size and weight and subject to packaging demands, or have lacked the fidelity often needed for the particular application.

### SUMMARY

According to an aspect of the disclosure, a wind sensor may include a spherical shell body, a multitude of pressure taps, and a multitude of pressure transducers. The pressure taps are coupled with the spherical shell body. The pressure taps fluidly communicate with an exterior of the spherical shell body. The pressure taps have varying and differing locations relative to one another at the spherical shell body, and more particularly at the exterior of the spherical shell body. The pressure transducers have connections with the pressure taps. With use of the wind sensor, per this embodiment, wind direction and wind velocity at the exterior of the spherical shell body are estimated. The estimations are made—according to this embodiment—based in part or more upon pressure measurements taken at the varying locations at the spherical shell body by the pressure transducers. Furthermore, the estimations of wind direction and wind velocity are made using an inverse mathematical model and via machine learning.

According to another aspect of the disclosure, a method and process of making wind direction and wind velocity estimations may involve various steps. In one step, pressure measurements are taken at a multitude of locations on a spherical shell body. In another step, the pressure measurements are utilized in an inverse mathematical model. In yet another step, the inverse mathematical model is developed with machine learning. And in another step, the wind direction and wind velocity estimations are made by way of the inverse mathematical model.

According to another aspect of the disclosure, a wind sensor may include a spherical shell body, a multitude of pressure taps, and a multitude of pressure transducers. The spherical shell body has an exterior wall. A multitude of openings resides in the exterior wall. The openings fluidly communicate with an exterior outside of the spherical shell body. The openings have different locations at the exterior wall with respect to one another. The pressure taps have a multitude of tubes. The tubes extend to the openings. The tubes fluidly communicate with the openings. The pressure transducers have connections with the pressure taps by way of the tubes.

### BRIEF DESCRIPTION OF THE DRAWINGS

Exemplary embodiments will hereinafter be described in conjunction with the appended drawings, wherein like designations denote like elements, and wherein:

FIG. 1 is a perspective view of an embodiment of a wind sensor;

FIG. 2 is a front view of the wind sensor;

FIG. 3 is a top view of the wind sensor;

FIG. 4 is a flow chart of an embodiment of a method of making wind direction and wind velocity estimations;

FIG. 5 illustrates another embodiment of the wind sensor;

FIG. 6 presents a graph of a simulation demonstrating pressure coefficient distribution over a sphere for various velocities, with positions (x/D) relative to the sphere plotted on an x-axis and pressure coefficient (C_{P} °C) plotted on a y-axis;

FIG. 7 presents a graph of a simulation demonstrating machine learning results for error for pitch (θ) angles of estimations of degrees ranging between −45° and +45° (i.e., −45°<θ<45°), with machine learning incidents plotted on a y-axis and with error in pitch (θ) angle estimation plotted on an x-axis;

FIG. 8 presents a graph of a simulation demonstrating machine learning results for error in speed (meters per second, m/s) of estimations, with machine learning incidents plotted on a y-axis and with error in speed estimation plotted on an x-axis; and

FIG. 9 presents a graph of a simulation demonstrating machine learning results for error in azimuth (ψ) angles of estimations of degrees ranging between 0° and 360° (i.e., 0°<ψ<360°), with predictions plotted on a y-axis and truth plotted on an x-axis.

### DETAILED DESCRIPTION

An embodiment of a wind sensor 10 is presented, as well as an embodiment of a method 100 of making wind flow direction and wind flow velocity (i.e., magnitude) estimations and predictions. The wind sensor 10 employs certain fundamentals of aerodynamics and machine learning capabilities in order to make wind condition estimations. For further-reaching installations and applications than past wind sensors, the wind sensor 10 is designed and constructed with size, weight, power, and cost (SWaP-C) optimizations—the wind sensor 10 possesses minimized size and packaging, and is lightweight, readying the wind sensor 10 for installations sensitive to these properties. The wind sensor 10 exhibits enhanced fidelity compared to past devices of comparable size and weight, and the wind sensor 10 can make wind condition estimations in three dimensions (i.e., U, V, and W) about its exterior. Furthermore, the wind sensor 10 has no moving parts which have proven prone to damage and dysfunction in severe weather conditions in past devices.

The wind sensor 10 and method 100 described herein have expansive applications and purposes including, but not limited to, civilian, commercial, military, recreational, and agricultural applications, and for use in UAV navigation control, fume tracking, anemotaxis, self-driving cars, wind farms, marine applications, and stationary weather stations, among many other possibilities. For agricultural applications, the wind sensor 10 and method 100 can be employed for more precise pesticide spraying procedures, as well as other agricultural chemical and solution spraying procedures. In an example, the wind sensor 10 could be mounted on a UAV to estimate wind condition for predicting the trajectory of dispensed chemicals and solutions for ensuring intended targeting. Another application of the wind sensor 10 and method 100 can involve recreation vehicles (RVs), commercial semi-trailer trucks, and other large vehicles. In these examples, the wind sensor 10 and method 100 could be employed for monitoring crosswind magnitudes amid travel and the detection of strong crosswinds that may pose risk of a rollover or some other unwanted event. Moreover, in a related application involving RVs, semi-trailer trucks, and other large vehicles, the wind sensor 10 and method 100 could be part of a larger system that controls vehicle speed based in part or more upon wind conditions in order to optimize fuel efficiency of the particular vehicle; here, estimated wind flow directions and velocities could be an input to the larger system for vehicle speed control and adjustments with respect to estimated wind conditions.

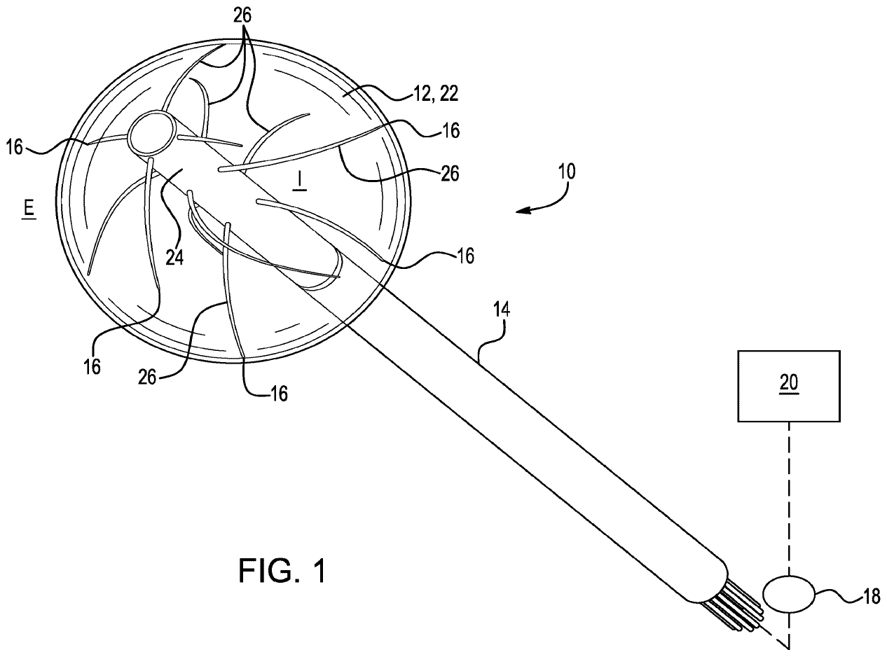

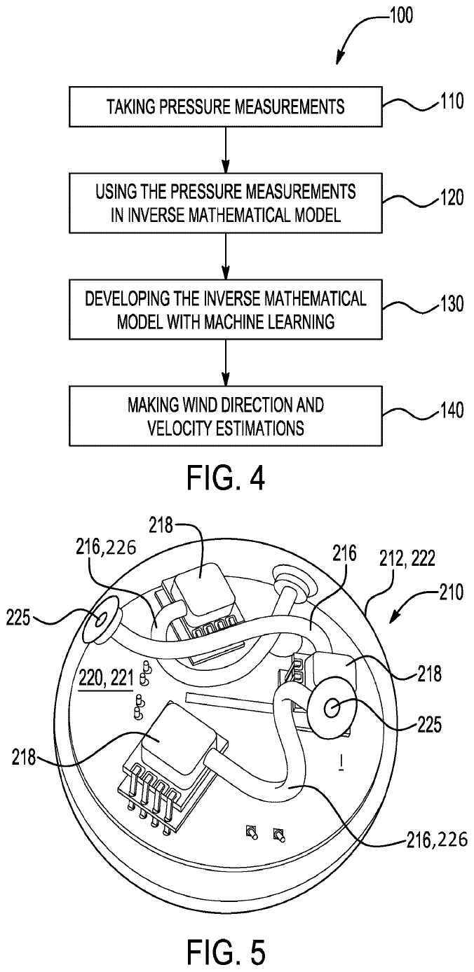

The wind sensor 10 and method 100 of making wind flow direction and wind flow velocity estimations and predictions can vary in different embodiments depending upon, among other potential factors, the desired accuracy of the wind condition estimations and predictions and the intended installation and application. It will become apparent to skilled artisans as this description advances that the wind sensor 10 could have more, less, and/or different components than those set forth with reference to the figures and described herein, and that the method 100 could have more, less, and/or different steps than those depicted in FIG. 4 and described herein. With reference to FIGS. 1-3, this embodiment of the wind sensor 10 includes a spherical shell body 12, a stem 14, a multitude of pressure taps 16, a multitude of pressure transducers 18, and a controller 20.

The spherical shell body 12 houses the pressure taps 16 and is exposed to surrounding wind conditions in application and amid use of the wind sensor 10 in order for the pressure taps 16 to accept the attendant wind flow of the surrounding wind conditions. The attendant wind flow facilitates wind pressure readings and measurements via the pressure taps 16 and pressure transducers 18. In one particular example embodiment, the spherical shell body 12 has an approximate two-inch (2″) diameter, and in another example the diameter of the spherical shell body 12 ranges from half an inch to three inches (0.5″-3.0″); still, the spherical shell body 12 can have other dimensions in other embodiments, some smaller and some larger than these examples. Since the spherical shell body 12 possesses a spherical and globe-like shape, wind can more readily flow around the shape, it has been found, enhancing fidelity of the wind pressure readings and measurements and minimizing or altogether precluding reading errors. The spherical shape facilitates wind pressure readings and measurements in three dimensions (i.e., U, V, and W) about an exterior E of the spherical shell body 12—for example, wind pressure readings and measurements encountered by the spherical shell body 12 horizontally and vertically relative thereto, as well as in other directions, can be readily gauged Further, the spherical shell body 12 has an exterior wall 22. The exterior wall 22 establishes and defines a hollow interior I of the spherical shell body 12. The exterior wall 22 can be composed of a plastic material, a metal material, or some other material, per varying embodiments. In another embodiment presented below, the spherical shell body 12 could also house and carry the pressure transducers 18 and the controller 20 within the interior I.

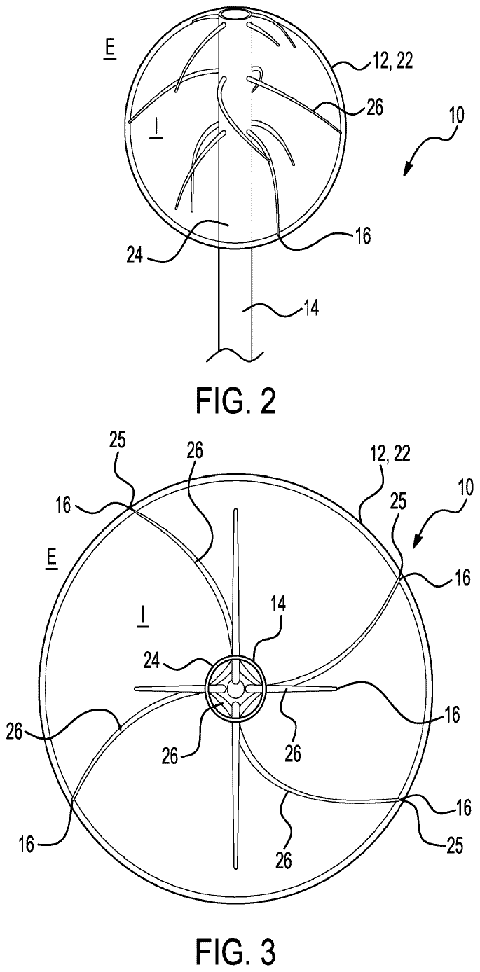

The stem 14 extends to the spherical shell body 12 and serves as an upright to support positioning of the spherical shell body 12 in installation. The pressure taps 16 and its tubes (introduced below) are received in the stem 14 and are routed to the pressure transducers 18 by way of the stem's interior, per this embodiment; still, in the embodiment in which the pressure transducers 18 and controller 20 are housed in the spherical shell body 12, the tubes would not be received and routed in the stem 14. The stem 14 can be tubular. In this embodiment, the stem 14 extends wholly through the interior I of the spherical shell body 12 from a bottom side and to a topside thereof (bottom and top are used here with reference to the orientation presented by FIG. 2); still, in other embodiments, the stem 14 need not extend wholly through the interior I and could instead exhibit an external mounting to the exterior wall 22. A wall 24 of the stem 14 can have throughways residing in its structure to receive the pressure taps 16 and its tubes. The pressure taps 16 and its tubes pass through the throughways. Like the exterior wall 22, the wall 24 can be composed of a plastic material, a metal material, or some other material, per varying embodiments.

The pressure taps 16 are coupled with the spherical shell body 12 and serve to gauge static surface and wind pressures at their respective locations and sites. The pressure taps 16 fluidly communicate with the exterior E of the spherical shell body 12, and have connections with the pressure transducers 18 via the fluid communication. The pressure taps 16 accept surrounding wind flow at their respective sites at the exterior wall 22. The quantity of pressure taps 16 can differ in varying embodiments, and can be dictated by the size of the spherical shell body 12 and the desired accuracy of the wind condition estimations and predictions. In general, it has been found that the greater the number of pressure taps 16 provided for the wind sensor 10, the greater the precision and accuracy of the wind condition estimations and predictions. In the embodiment of FIGS. 1-3, there are a total of twelve pressure taps 16; still other quantities are possible in other embodiments including more or less than twelve, and including six pressure taps 16 per a particular embodiment or eight pressure taps 16. Openings 25 (FIG. 3) defined in and residing in the exterior wall 22 effect fluid communication between the pressure taps 16 and the exterior E, and are open to and fluidly communicate therewith. Except for the openings 25, the exterior wall 22 of the spherical shell body 12 is otherwise a substantially solid structure. The pressure taps 16 extend from these openings 25. The openings 25 have immediate and direct exposure to the exterior E. The sizes and shapes of the openings 25 can complement those of the pressure taps 16 at interfaces thereamong, and can be configured to facilitate fluid communication thereamong. In certain particular example embodiments, the openings 25 have an approximate diameter of 0.34 millimeters (mm) or less; still, the openings 25 can have other diameter values in other embodiments, some larger than this example. It has been found that, according to certain embodiments, having diameters of the openings 25 less than approximately 0.34 mm can facilitate wind flow measurements by the wind sensor 10. Further, the pressure taps 16 include tubes 26 that span from the openings 25 and through the interior I of the spherical shell body 12. The tubes 26 fluidly communicate with the openings 25, and extend to the pressure transducers 18.

Depending on the quantity, the pressure taps 16 can have coupling locations and sites at the exterior wall 22 that differ with respect to one another. The locations and sites can be configured in order to facilitate wind pressure readings and measurements in three dimensions about the exterior E of the spherical shell body 12. The locations and sites can be equally and symmetrically spaced around the exterior wall 22 with respect to one another, as an example. In the embodiment with six pressure taps 16, for instance, a first pressure tap can have a first location at the exterior wall 22, a second pressure tap can have a second location at the exterior wall 22, a third pressure tap can have a third location at the exterior wall 22, a fourth pressure tap can have a fourth location at the exterior wall 22, a fifth pressure tap can have a fifth location at the exterior wall 22, and a sixth pressure tap can have a sixth location at the exterior wall 22. The first location and second location can be set approximately one-hundred-and-eighty-degrees (180°) from each other relative to the spherical shell body 12, the third location and fourth location can be set approximately one-hundred-and-eighty-degrees (180°) from each other relative to the spherical shell body 12, and the fifth location and sixth location can be set approximately one-hundred-and-eighty-degrees (180°) from each other relative to the spherical shell body 12. Further, the first and second locations can be set approximately ninety degrees (90°) from the third and fourth locations relative to the spherical shell body 12, and the third and fourth locations can be set approximately ninety degrees (90°) from the fifth and sixth locations relative to the spherical shell body 12. In this example embodiment with six pressure taps 16, the individual pressure taps are arranged uniformly about the spherical shell body 12, and ninety degrees (90°) from one another. Still, many other locations and sites are possible, including those that do not necessarily exhibit an equidistant and symmetrical arrangement.

The pressure transducers 18 have connections with the pressure taps 16 and receive wind pressure readings and measurements therefrom for conversion to electrical output signals to the controller 20. Together, the pressure transducers 18 and pressure taps 16 serve to measure surface pressure at an exterior surface of the exterior wall 22 exposed to surrounding and outside wind conditions. The connections can be via ports of the pressure transducers 18, as an example. The electrical output signals are representative of the wind pressure readings and measurements. The pressure transducers 18 electrically communicate with the controller 20. While only a single pressure transducer 18 is depicted in FIG. 1 in schematic representation, there may be multiple pressure transducers 18 per varying embodiments such as one pressure transducer 18 for each pressure tap 16. So, for example, in the embodiment of twelve pressure taps 16, a total of twelve pressure transducers 18 could be provided. According to a particular embodiment, the pressure transducers 18 are in the form of miniature amplified output pressure sensors supplied by the Amphenol All Sensors Company of California, U.S.A. (www.allsensors.com) and under the part number 1 INCH-D1-4V-MINI; still, in other embodiments other types and kinds of pressure transducers supplied by other companies can be used.

The controller 20 receives the electrical output signals from the pressure transducers 18 and employs an inverse mathematical model and machine learning in order to estimate the wind flow directions and wind flow velocities at the spherical shell body 12 amid use of the wind sensor 10. According to varying embodiments, the controller 20 can be a component of an assemblage that includes the wind sensor 10, or can be a component of a larger application assemblage such as a UAV component. As set forth above, when the controller 20 is a component of the wind sensor 10, the controller 20 could be housed in the spherical shell body 12 and carried thereby for a compact configuration. Moreover, the controller 20 can be a microcontroller, per various embodiments.

The inverse mathematical model serves to yield wind flow direction and wind flow velocity estimations and predictions of the wind that acts on the wind sensor 10 at the spherical shell body 12. The inverse mathematical model is developed by machine learning capabilities, per below. The estimations and predictions are based on the wind pressure readings and measurements of the pressure taps 16, and the distribution of the wind pressure readings and measurements around the spherical shell body 12 at the various coupling locations and sites of the pressure taps 16. The wind pressures constitute model parameters of the inverse mathematical model. In general, the inverse mathematical model utilizes certain aerodynamic properties of the wind flow around the spherical shell body 12 in its estimations of wind flow directions and velocities. According to an embodiment, the aerodynamic properties can include, but are not limited to, one or more of: pressure coefficient distribution around the spherical shell body 12, Reynolds number, angle at which the boundary layer separates, location of stagnation point, and air density.

Machine learning capabilities are used to develop the inverse mathematical model for the estimations and predictions of the wind flow directions and wind flow velocities amid use of the wind sensor 10. The machine learning capabilities are incorporated with the inverse mathematical model. The machine learning can involve neural networks, per an embodiment. The machine learning capabilities can establish a relationship between the wind pressure readings and measurements of the pressure taps 16, and the distribution of the wind pressure readings and measurements around the spherical shell body 12 at the various coupling locations and sites of the pressure taps 16, and wind flow direction and wind flow velocities, in order to perform the estimations and predictions. Training was conducted for the machine-learning enabled inverse mathematical model offline and pre-installation for calibration purposes of the model. Computational fluid dynamics (CFD) was performed with known wind flow directions and wind flow velocities, and wind pressure readings and measurements were obtained around the spherical shell body 12 for machine learning training purposes; this data was fed to the machine-learning enabled inverse mathematical model. Further, the machine learning training and model calibration could be carried out via wind tunnel experimentations, as an additional example.

With reference now to FIG. 4, the method 100 of making wind flow direction and wind flow velocity estimations and predictions can involve differing steps according to varying embodiments and performed in varying sequences and orders. In the embodiment of FIG. 4, the method 100 includes a first step 110 of taking pressure readings and measurements at a multitude of locations on the spherical shell body 12 of the wind sensor 10. A second step 120 involves using the pressure readings and measurements in the inverse mathematical model. And a third step 130 involves developing the inverse mathematical model with machine learning in order to make the wind flow direction and wind flow velocity estimations and predictions. Lastly, per this embodiment, a fourth step 140 involves making the wind direction and wind velocity estimations by way of the developed inverse mathematical model. Still, other steps of the method 100 according to other embodiments may include using pressure distribution of the pressure readings and measurements in the inverse mathematical model, making wind condition estimations in three dimensions, and/or using neural networks to develop the inverse mathematical model.

Furthermore, parameters and specifications of the wind sensor 10 and its components may be dictated by the intended application and the expected wind conditions subject to estimation and prediction. As examples, in UAV navigation control applications, pressure taps and transducers could be selected on the basis of experiencing maximum wind flow velocities of thirty miles-per-hour (30 mph) to 50 mph, or more; in large vehicle applications such as semi-trailer trucks, pressure taps and transducers could be selected on the basis of experiencing maximum wind flow velocities of 140 mph, or more; and in military chemical defense applications, the pressure taps and transducers could be selected on the basis of experiencing maximum wind flow velocities of 10 mph, or more.

Still further, the wind sensor 10 could have other designs, constructions, and components according to other embodiments. For example, the wind sensor 10 could be equipped with a humidity sensor and/or a temperature sensor. In another example, the wind flow direction and wind flow velocity estimations and predictions could be outputted and communicated to user or operator devices or elsewhere via wired communications or wireless communications (e.g., Wi-Fi, Bluetooth) for further use.

With reference now to FIG. 5, a second embodiment of a wind sensor 210 is presented. In the second embodiment, corresponding components and elements are numbered similarly but with the numerals 2xx as an indication of this second embodiment. For example, the wind sensor is indicated by numeral 10 in the first embodiment, and is correspondingly indicated by numeral 210 in the second embodiment. Moreover, similarities may exist between the first embodiment and the second embodiment, some of which may not be repeated here in the description of the second embodiment.

The wind sensor 210 of FIG. 5 includes a spherical shell body 212, a multitude of pressure taps 216, a multitude of pressure transducers 218, and a controller 220. An exterior wall 222 of the spherical shell body 212 establishes and defines a hollow interior I Unlike the first embodiment, in this second embodiment the spherical shell body 212 houses other components of the wind sensor 210 at its interior I. It has been found that, in certain applications and uses, locating components inside the spherical shell body 212—and lacking components at the exterior and outside of the spherical shell body 212—provides more efficient and effective overall packaging of the wind sensor 210, and provides increased robustness in performance. As depicted, the pressure taps 216, pressure transducers 218, and controller 220 are all located and positioned within the interior I of the spherical shell body 212. Further, while only three pressure taps 216 are shown in the view of FIG. 5, a total of six pressure taps 216 are provided in the second embodiment (i.e., three pressure taps 216 are unshown and hidden by a circuit board and are located at an opposite side of spherical shell body 212). The pressure taps 216 each include a tube 226 that are wholly confined within the interior I of the spherical shell body 212. As before, the tubes 226 fluidly communicate with openings 225 residing in the exterior wall 222. The openings 225 are depicted by an exaggerated size for demonstrative purposes in the figure. Like the pressure taps 216 and tubes 226, the pressure transducers 218 are wholly confined within the interior I of the spherical shell body 212. Three pressure transducers 218 are shown for each of the three pressure taps 216 shown. Three more pressure transducers 218 for the three unshown pressure taps 216 are provided in this embodiment. The pressure transducers 218 are mounted to and carried by a circuit board 221, The circuit board 221 is also wholly confined within the interior I of the spherical shell body 212. The controller 220 is a microcontroller in the second embodiment, and is carried at the circuit board 221.

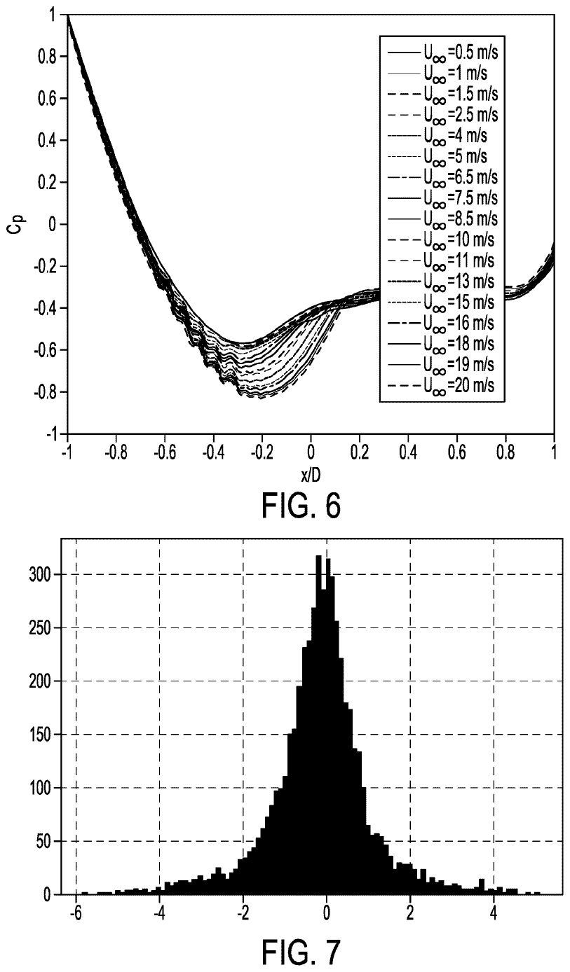

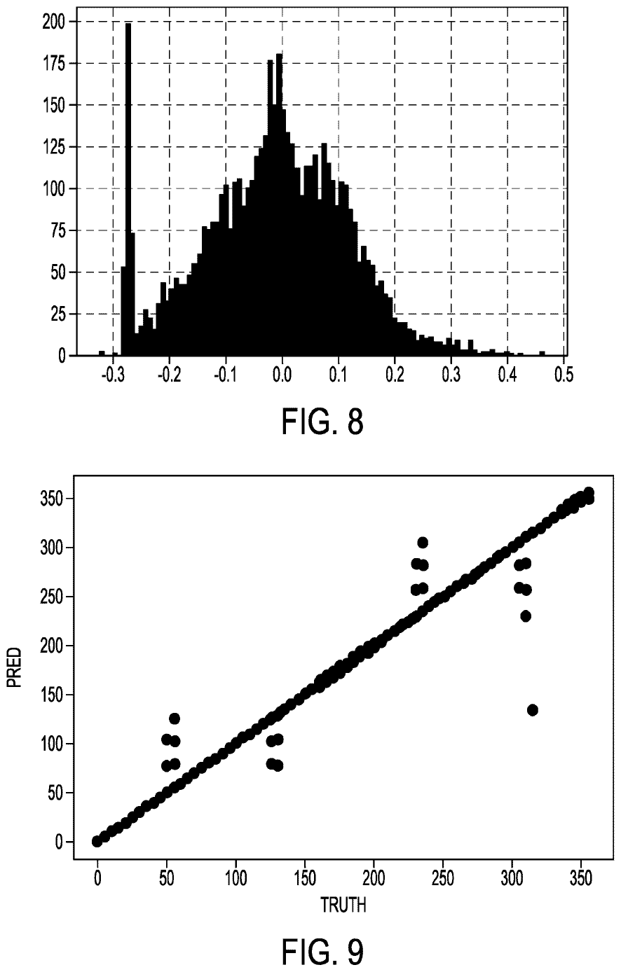

With reference now to the graph of FIG. 6, computational fluid dynamics (CFD) simulated results are presented in graphical form that demonstrate pressure coefficient distribution over a sphere for velocities that range from 0.5 meters per second (m/s) to 20 m/s (i.e., U∝=0.5 m/s to U∝=20 m/s). The sphere in this simulation serves as a representation of the spherical shell body 12, 212 of the wind sensor 10, 210. In the graph, positions (x/D) of the sphere is plotted on an x-axis, and pressure coefficient (C_{P}) is plotted on a y-axis. The lines in the graph are the velocities. For the sphere positions, a leading edge and surface of the sphere in confrontation with the simulated flow stream is represented on the left side of the x-axis, while a trailing edge and surface of the sphere with respect to the simulated flow stream is represented on the right side of the x-axis. Furthermore, the graphs of FIGS. 7-9 demonstrate the efficacy and general precision of the machine learning capabilities for the estimations and predictions of the wind flow directions and wind flow velocities amid use of the wind sensor 10, 210. Machine learning results involving neural networks are presented in graphical form in FIGS. 7-9. In FIG. 7, machine learning results for error for pitch (θ) angles of estimations of degrees ranging between −45° and +45° (i.e., −45°<θ<45°) are shown. Machine learning incidents are plotted on a y-axis in the graph of FIG. 7, and error in pitch (θ) angle estimation is plotted on an x-axis. The numeral zero (0) on the x-axis represents the absence of error. In FIG. 8, machine learning results for error in speed (meters per second, m/s) of estimations are shown. Machine learning incidents are plotted on a y-axis in the graph of FIG. 8, and error in speed estimation is plotted on an x-axis. In FIG. 9, machine learning results for error in azimuth (ψ) angles of estimations of degrees ranging between 0° and 360° (i.e., 0°<ψ<360°) are shown. Predictions and estimations are plotted on a y-axis in the graph of FIG. 9, and truth is plotted on an x-axis. In the graphs, skilled artisans will appreciate that various simulations may yield varying results.

As used herein, the terms “general” and “generally” and “substantially” are intended to account for the inherent degree of variance and imprecision that is often attributed to, and often accompanies, any design and manufacturing process, including engineering tolerances- and without deviation from the relevant functionality and intended outcome-such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other representation.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A wind sensor, comprising:
a spherical shell body;
a plurality of pressure taps coupled with the spherical shell body and fluidly communicating with an exterior of the spherical shell body, the plurality of pressure taps having varying locations at the spherical shell body relative to one another; and
a plurality of pressure transducers having connections with the plurality of pressure taps;
wherein wind direction and wind velocity at the exterior of the spherical shell body are estimated based at least in part upon pressure measurements taken at the varying locations at the spherical shell body by the plurality of pressure transducers and using an inverse mathematical model and machine learning.

2. The wind sensor as set forth in claim 1, wherein the spherical shell body has an interior, and the plurality of pressure taps has a plurality of tubes that span through the interior.

3. The wind sensor as set forth in claim 2, wherein the spherical shell body has an exterior wall establishing the interior, a plurality of openings resides in the exterior wall, and the plurality of tubes fluidly communicates with the plurality of openings.

4. The wind sensor as set forth in claim 1, wherein the plurality of pressure taps comprises at least a first pressure tap having a first location at the spherical shell body, a second pressure tap having a second location at the spherical shell body, a third pressure tap having a third location at the spherical shell body, a fourth pressure tap having a fourth location at the spherical shell body, a fifth pressure tap having a fifth location at the spherical shell body, and a sixth pressure tap having a sixth location at the spherical shell body.

5. The wind sensor as set forth in claim 1, further comprising a stem extending from the spherical shell body at the exterior, the plurality of pressure taps having a plurality of tubes that span through an interior of the spherical shell body and that span through the stem.

6. The wind sensor as set forth in claim 1, wherein the wind direction and wind velocity estimations are based upon pressure distribution of the pressure measurements at the exterior of the spherical shell body.

7. The wind sensor as set forth in claim 1, wherein the plurality of pressure taps is coupled at an exterior wall of the spherical shell body via a symmetrical arrangement relative to one another, and the wind direction and wind velocity estimations are based upon pressure distribution of the pressure measurements taken by the plurality of pressure transducers via the symmetrically-arranged plurality of pressure taps.

8. The wind sensor as set forth in claim 1, wherein the wind direction and wind velocity estimations are three-dimensional wind direction and wind velocity estimations with respect to the spherical shell body.

9. The wind sensor as set forth in claim 1, further comprising a controller receiving the pressure measurements from the plurality of pressure transducers, and the wind direction and wind velocity estimations are performed via the controller.

10. The wind sensor as set forth in claim 9, wherein the controller and the plurality of pressure transducers are located within an interior of the spherical shell body.

11. The wind sensor as set forth in claim 1, wherein the machine learning involves neural networks.

12. The wind sensor as set forth in claim 1, further comprising a humidity sensor, a temperature sensor, or both a humidity sensor and a temperature sensor.

13. A method of making wind direction and wind velocity estimations, the method comprising:
taking pressure measurements at a plurality of locations on a spherical shell body;
using the pressure measurements in an inverse mathematical model;
developing the inverse mathematical model with machine learning; and
making the wind direction and wind velocity estimations via the inverse mathematical model.

14. The method of making wind direction and wind velocity estimations as set forth in claim 13, further comprising taking the pressure measurements via a plurality of pressure taps situated at the plurality of locations on the spherical shell body and via a plurality of pressure transducers having connections with the plurality of pressure taps.

15. The method of making wind direction and wind velocity estimations as set forth in claim 13, further comprising using pressure distribution of the pressure measurements with respect to the plurality of locations around the spherical shell body to make the wind direction and wind velocity estimations.

16. The method of making wind direction and wind velocity estimations as set forth in claim 13, further comprising using aerodynamic properties of wind flow with respect to the spherical shell body in making the wind direction and wind velocity estimations via the inverse mathematical model.

17. A wind sensor, comprising:
a spherical shell body having an exterior wall, a plurality of openings residing in the exterior wall and fluidly communicating with an exterior of the spherical shell body, the plurality of openings having differing locations at the exterior wall relative to one another;
a plurality of pressure taps having a plurality of tubes, the plurality of tubes extending to the plurality of openings and fluidly communicating with the plurality of openings; and
a plurality of pressure transducers having connections with the plurality of pressure taps via the plurality of tubes.

18. The wind sensor as set forth in claim 17, further comprising a controller, the controller residing on a circuit board, wherein the exterior wall of the spherical shell body defines an interior, the plurality of pressure taps and plurality of tubes and plurality of pressure transducers and controller and circuit board all being located within the interior of the spherical shell body, and wherein wind direction and wind velocity estimations at the exterior of the spherical shell body are made via the plurality of openings and the plurality of pressure taps and the plurality of pressure transducers.

19. The wind sensor as set forth in claim 17, further comprising a stem extending from the spherical shell body and situated at least partly at the exterior of the spherical shell body, the exterior wall of the spherical shell defining an interior, the plurality of tubes spanning through the interior and through the stem.
